(19) United States
(12) Patent Application Publication
(10) Pub. No.: US 2009/0304094 A1
(43) Pub. Date: Dec. 10, 2009

(54) Dual Carrier Modulation Soft Demapper

(75) Inventors: R. Simon Sherratt, Woodley (GB); Runfeng Yang, Reading (GB); Oswaldo Cadenas, Reading (GB)

Correspondence Address: SMITH FROHWEIN TEMPEL GREENLEE BLAHA, LLC, Two Ravinia Drive, Suite 700, ATLANTA, GA, 30346, US

(73) Assignee: THE UNIVERSITY OF READING WHITEKNIGHTS, Reading (GB)

(21) Appl. No.: 12/132,743

(22) Filed: Jun. 4, 2008

(51) Int. Cl. H04L 27/28

(52) U.S. Cl. 375/260

(57) ABSTRACT

An Orthogonal Frequency Division Multiplexing (OFDM) communication system with a transmitter and a receiver. The transmitter is arranged to transmit channel estimation sequences on each of a plurality of band groups, or bands, and to transmit data on each of the band groups or bands. The receiver is arranged to receive the channel estimation sequences for each band group or band to calculate channel state information from each of the channel estimation sequences transmitted on that band group or band and to form an average channel state information. The receiver receives the transmitted data, transforms the received data into the frequency domain, equalizes the received data using the channel state information, demaps the equalized data to re-construct the received data as soft bits and modifies the soft bits using the averaged channel state information.

### FIELD OF THE INVENTION

The present invention relates to Orthogonal Frequency Division Multiplexing (OFDM) communication systems, and in particular to demappers in such systems.

### BACKGROUND OF THE INVENTION

In February 2002 the USA Federal Communications Commission (FCC) agreed to allocate 7500 MHz spectrum from 3.1-10.6 GHz for unlicensed use for ultra-wideband (UWB) devices [1]. Many different UWB high data rate physical layers were proposed. The 802.15.3a Task Group converged into two main proposals: the Multiband Orthogonal Frequency Division Multiplexing (MB-OFDM) solution [2], and the Direct-Sequence (DS) UWB solution [3]. Recently, in 2005 the WiMedia Alliance working with ECMA International announced the establishment of the WiMedia MB-OFDM UWB radio platform as the global UWB standard [4]. ECMA-368 [5], published in December 2005, is the first version of UWB Physical (PHY) Layer and Medium Access Control (MAC) layer standard from WiMedia Alliance. ECMA-368 is also chosen as the radio platform of high data rate wireless specifications for high-speed Wireless USB and Fast Bluetooth.

ECMA-368 specifies MB-OFDM to occupy 14 bands, each band with a bandwidth of 528 MHz. The first 12 bands are then grouped into 4 band groups (BG1-BG4), and the last two bands are grouped into a fifth band group (BG5). The advantage of the grouping is that the transmitter and receiver can process a smaller bandwidth signal while taking advantages from frequency hopping. Each band can support up to 480 Mbit/s. The OFDM symbol is the basic quanta of MB-OFDM based UWB radio. Each OFDM symbol is 312.5 ns long including 70.08 ns of zero-padded suffix to aid multipath interference mitigation and settling times of the transmitter and receiver. Each OFDM symbol is constructed from the Inverse Fast Fourier Transform (IFFT) of a set of 128 complex valued carriers made from 100 data carriers, 12 pilot carriers, 6 NULL valued carriers and 10 guard carriers. The 10 guard carriers used for mitigating intersymbol interference (ISI) are located on either edge of the OFDM Symbol and they are the same value as the 5 outermost data carriers. In addition, the guard carriers are considered as another form of time and frequency diversity resulting in improved performance for the receiver [6].

To operate the PHY service interface to the MAC service, a Packet Layer Convergence Protocol (PLCP) sublayer is defined, which provides a method for converting a PSDU (PLCP Service Data Unit) into a PPDU (PLCP Packet Data Unit). So the PPDU is composed of three components (shown in FIG. 1): the PLCP preamble (containing the Packet/Frame Sync and the Channel Estimation sequence), the PLCP header, and the PSDU.

To transmit a PSDU, ECMA-368 has eight transmission modes by applying various levels of coding and diversity. Frequency-domain spreading, time-domain spreading, and Forward Error Correction (FEC) coding are used to offer 53.3, 80, 106.7, 160, 200, 320, 400 or 480 Mbit/s to the MAC layer. After bit interleaving, the coded and interleaved binary data sequence are mapped onto a complex constellation. Two complex constellation schemes, Quadrature Phase Shift Keying (QPSK) and Dual Carrier Modulation (DCM), are adopted as the mapping techniques. DCM [7] was introduced to the MB-OFDM proposal as one of the enhancement changes to create the current WiMedia Alliance standard. For data rates 200 Mbit/s and lower, a QPSK constellation is used. For data rates 320 Mbit/s and higher, DCM is used as a multi-dimensional constellation but while also adding a level of symbol diversity.

In the MB-OFDM system, Channel State Information (CSI) may be used to incorporate into enhancing the channel decoder's error correction performance [8][9][10]. Each data carrier has a different CSI, hence the more reliable a CSI is applied to the associated data carrier; the better the decoding performance can be.

### SUMMARY OF THE INVENTION

The present invention provides an OFDM communications system comprising a transmitter and a receiver, wherein the transmitter is arranged to: transmit a plurality channel estimation sequences on each of a plurality of band groups, or bands, and to transmit data on each of the band groups or bands; and the receiver is arranged to: receive the channel estimation sequences; for each band group or band to calculate channel state information from each of the channel estimation sequences transmitted on that band group or band and to form an average channel state information; receive the transmitted data; transform the received data into the frequency domain; equalize the received data using the channel state information; demap the equalized data to re-construct the received data as soft bits; and modify the soft bits using the averaged channel state information.

Some embodiments of the present invention provide an improved efficiency soft-output DCM demapper suitable for ECMA-386, and other OFDM systems, that exploits a CSI aided scheme coupled with the band hopping information to maximize soft demapping performance.

Preferred embodiments of the present invention will now be described by way of example only with reference to the accompanying drawings.

### BRIEF DESCRIPTION OF THE DRAWINGS

FIG. 1 is a diagram showing the content of a PPDU.

FIG. 2 is a functional diagram of a communications system according to an embodiment of the invention.

FIG. 3 is a diagram showing details of part of the system of FIG. 2.

FIG. 4 is a diagram showing averaging of CSI data within one time frequency coding example of the system of FIG. 2.

FIGS. 5a and 5b are diagrams showing DCM constellation mapping used in the system of FIG. 2.

FIGS. 6a, 6b and 6c are diagrams showing the performance of the system of FIG. 2 compared to other systems as packet error rate (PER) as a function of distance.

### DETAILED DESCRIPTION OF THE PREFERRED EMBODIMENTS

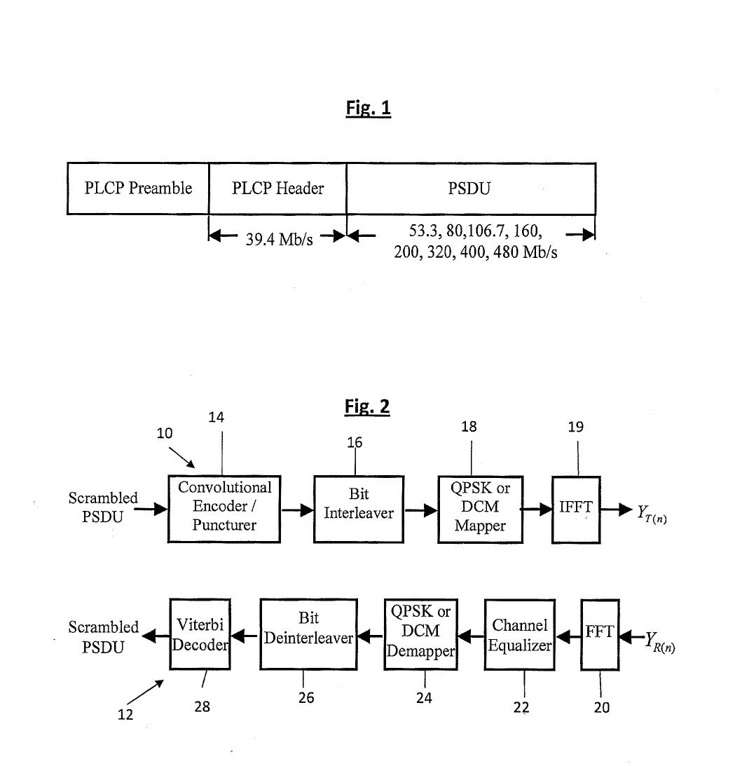

Referring to FIG. 2 a communication system comprises a transmitter 10 and a receiver 12. The transmitter 10 comprises a convolutional coder/puncturer 14 which is arranged to receive data in the form of scrambled PSDUs, and to perform coding and puncturing on it. A bit interleaver 16 is arranged to receive the data from the coder 14 and to perform an interleaving operation on it. A mapper 18, which in this embodiment is a DCM mapper, is arranged to receive the interleaved data and to map it as will be described in more detail below. Finally an inverse fast Fourier transform (IFFT) unit 19 is arranged to transform the data into an analogue signal Y_{T(n)} in the form of an OFDM symbol for transmission. The receiver 12 comprises an FFT unit 20 which is arranged to transform the received signal YR₍ₙ₎ back to the digital frequency domain. A channel equalizer 22 is arranged to perform channel equalization based on channel estimation information, and a demapper 24 is arranged to perform demapping on the equalized signal to generate soft bits which have a sign + or − to indicate a value of 0 or 1 and a magnitude, which indicates a reliability associated with the value of the bit. The data is then arranged to be de-interleaved by the de-interleaver 26 and then decoded by a Viterbi decoder 28 to obtain the scrambled PSDU. This is then unscrambled to obtain the original PSDU.

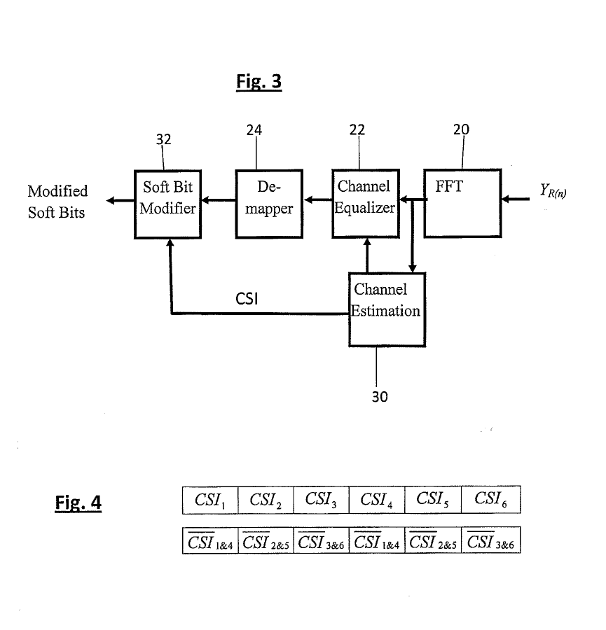

Referring to FIG. 3, which shows the functionality of the receiver in more detail, a channel estimation block 30 is arranged to receive channel estimation data sequences sent by the transmitter 10 and received by the receiver 12 and to compare them with stored copies of the same data sequences. From this comparison the channel estimation block 30 is arranged to derive channel estimation data, which is the ratio of the received signal to the transmitted signal for each frequency sub-channel. This ratio includes phase and amplitude information and provides an indication of the different effects of the transmission channel on different frequency components of the transmitted signal, which is used in the equalization process. In this embodiment the channel estimation information is also used to generate channel state information (CSI) which is used to modify the output of the demapper, as will be described in more detail below.

In this embodiment the mapping and demapping is performed using DCM constellation mapping. In DCM constellation mapping, the binary serial input data, coded and interleaved from scrambled PSDU, are divided into groups of 200 bits, and then these 200 bits are further grouped into 50 groups of 4 bits. Each group of 4 bits is represented as (b[g(k)], b[g(k)+1], b[g(k)+50], b[g(k)+51]), where kε[0 . . . 49] and

$$g ( k ) \{ \begin{matrix}2 k & k ∈ [ 0 … 24 ] \\ 2 k + 50 & k ∈ [ 25 … 49 ]\end{matrix} \qquad ( 1 )$$

In QPSK constellation mapping, the coded and interleaved binary bit values b[i]ε{0,1} are mapped into bipolar symbols X(i)ε{−1,1}. The DCM mapping can be derived from applying two different matrixes to multiply the bipolar symbols X(i) of QPSK mapping to obtain a complex number pair [yₙ, yₙ₊₅₀], shown in (2). Equation (2) can be simplified as (3).

$$\begin{matrix}{[ \begin{matrix}{y}_{n} \\ {y}_{n + 50}\end{matrix} ]}_{{↑}_{{OFDM}_{Modulation}}} = \frac{1}{\sqrt{10}} {( [ \begin{matrix}2 \\ 1\end{matrix} ] \cdot ( {x}_{g ( k )} + j {x}_{g ( k ) + 50} ) + [ \begin{matrix}1 \\ - 2\end{matrix} ] \cdot ( {x}_{g ( k ) + 1} + j {x}_{g ( k ) + 51} ) )}_{\begin{matrix} ↑ & & & & ↑ & & & & & ↑ & & & & & & ↑ & & & & & \\ DCM & & & & QPSK & & & & & DCM & & & & & & QPSK & & & & & \end{matrix}} & ( 2 ) \\ [ \begin{matrix}{y}_{n} \\ {y}_{n + 50}\end{matrix} ] = \frac{1}{\sqrt{10}} [ \begin{matrix}2 & 1 \\ 1 & - 2\end{matrix} ] [ \begin{matrix}{x}_{g ( k )} + j {x}_{g ( k ) + 50} \\ {x}_{g ( k ) + 1} + j {x}_{g ( k ) + 51}\end{matrix} ] & ( 3 )\end{matrix}$$

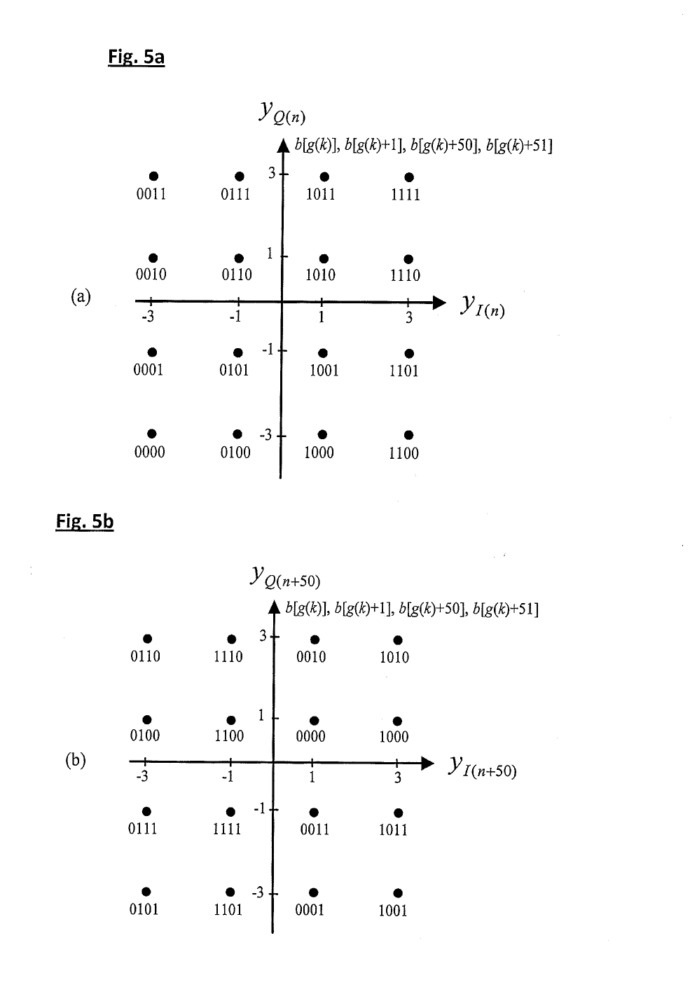

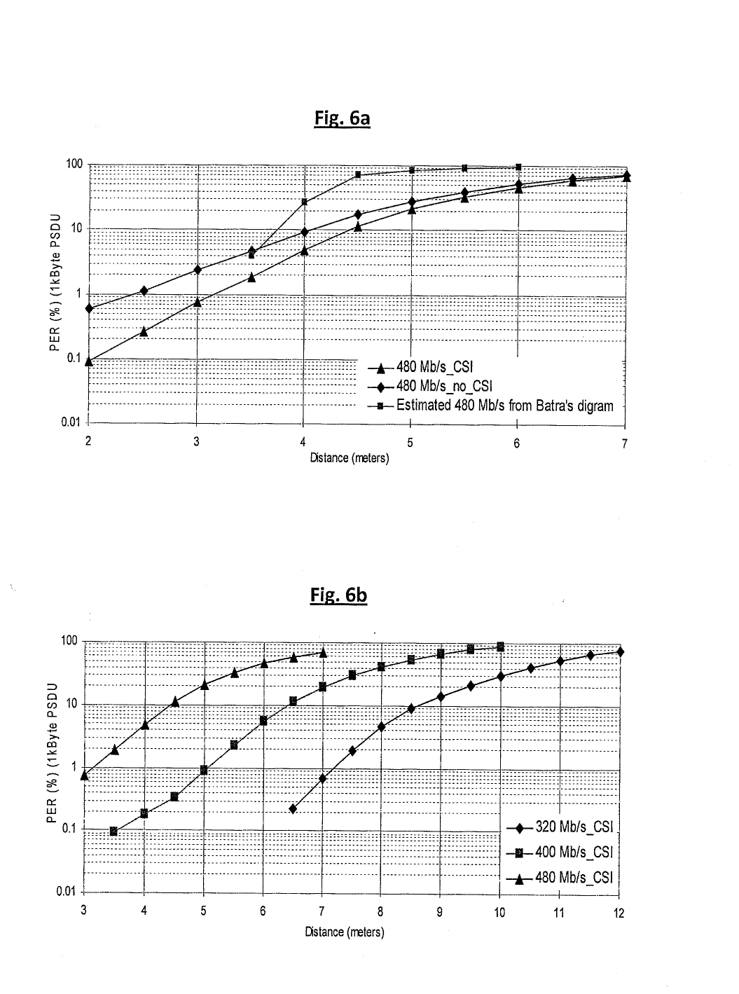

The normalization factor, KMOD=1/\sqrt{10}, is used to normalize the average symbol power to 1 in the DCM. Therefore the complex number pair [yₙ, yₙ+50] is formed into two four-dimensional constellations as shown in FIGS. 5a and 5b. Moreover the two complex numbers are allocated into two individual OFDM sub-carriers separated by at least 200 MHz, which can have frequency diversity gain for robustness against multi-path and interference.

In the OFDM modulation, the OFDM sub-carriers suffer from different noise power, for example, echoes, deep fades, etc. Particularly the noise effect of the frequency domain equalization process can degrade the soft-decision demapping. Each OFDM sub-carrier position has a dynamic estimation for the data reliability. This dynamic estimation in frequency-domain is defined as Channel State Information (CSI). Each data carrier has a potentially different CSI based on the power of the channel estimate at that frequency. Therefore the more CSI that can be taken the more reliable the CSI estimation is in the presence of multipath interference to offer a better demapping result.

Least Square (LS) equalization is one of the popular equalization methods for the OFDM based systems and has low complexity to implement. ECMA-368 defines 6 stored channel estimation (CE) sequences in blocks of 122 contained in the 6 OFDM symbols of the PLCP preamble. The basic LS CSI for each equalized data sequence can be calculated from the received and stored CE sequences transmitted on the same band group (band?) and given by

$$CSI = \vert \frac{CEr}{CEs} \vert \qquad ( 4 )$$

where CEr is the received CE sequence and CEs is the stored a priori CE sequence.

It should be noted that CEr/CEs includes both phase and amplitude information, i.e. information about the Q and I components of each frequency component of the sequences, whereas CSI as the modulus of CEr/CEs is a scalar term indicative of the power of each frequency component of the sequences.

A Time-Frequency Code (TFC), shown in Table 1, is given to the PHY from the MAC to define the hopping sequence across the selected band group (BG) while hopping is only performed in TFC1-4 with TFC 5-7 each representing use of only one band gap and no hopping [5].

TABLE 1
Time-Frequency Codes for Band Group 1

| | |
|---|---|
| TFC | Band_ID for TFC |

| | | | | | | |
|---|---|---|---|---|---|---|
| 1 | 1 | 2 | 3 | 1 | 2 | 3 |
| 2 | 1 | 3 | 2 | 1 | 3 | 2 |
| 3 | 1 | 1 | 2 | 2 | 3 | 3 |
| 4 | 1 | 3 | 2 | 1 | 3 | 2 |
| 5 | 1 | 1 | 1 | 1 | 1 | 1 |
| 6 | 2 | 2 | 2 | 2 | 2 | 2 |
| 7 | 3 | 3 | 3 | 3 | 3 | 3 |

Taking the 6 CE sequences and the selected TFC code (TFC=1) for the band hopping can create the 6 different blocks of CSI. Moreover, averaging the different blocks of CSI derived for the same band can produce a more reliable CSI in the time invariant or slowly changing channel with respect to the frame time. The first block of CSI is averaged with the fourth block of CSI as both are derived from data transmitted on the first band, while the second one is averaged with the fifth one as both of them are derived from data transmitted on the second band, and the third one is averaged with the sixth one as both of them are derived from data transmitted on the third band. Then the three new averaged CSI blocks and the copy of these blocks replace the previous CSI blocks in order, shown in FIG. 4.

When the DCM is involved, one constellation point is related to two different OFDM sub-carriers allocated separately by 200 MHz, so the frequency diversity can lead to two different CSI (CSIₙ, CSIₙ₊₅₀) for any particular bit of data, associated with the two data sub-carrier frequencies related to the constellation point onto which it was coded. Then the last stage of the proposed CSI is, for any soft bit, to use the smaller of the two averaged CSI ( C̅S̅I̅s) as the more reliable CSI from the two different CSI, to modify the soft bit.

The DCM soft demapping of this embodiment exploits CSI as will now be explained. The receiver converts each time-domain OFDM symbol into the frequency-domain via the Fast Fourier Transform (FFT). Then Channel Estimation and symbol Equalization follow. The DCM demapper 24 performs demapping the equalized complex numbers, related to two different sub-carriers, back to a group of 4 soft bits, and then outputs groups of 200 soft-bits. The DCM soft-demapper 24 employs a related matrix factor to combine the two equalized complex numbers previously transmitted on different sub-carriers into Maximum Likelihood (ML) soft bits.

$$[ \begin{matrix}{x}_{Rg ( k )} + j {x}_{Rg ( k ) + 50} \\ {x}_{Rg ( k ) + 1} + j {x}_{Rg ( k ) + 51}\end{matrix} ] = \frac{\sqrt{10}}{5} [ \begin{matrix}2 & 1 \\ 1 & - 2\end{matrix} ] [ \begin{matrix}{y}_{Rn} \\ {y}_{Rn + 50}\end{matrix} ] \qquad ( 5 )$$

By eliminating the factor \sqrt{10}/5 the DCM soft-demapper can still remain the same demapping performance. Therefore the group of 4 soft bits can be obtained as shown in (6),

b₁=2I_{R n}+I_{R n+50} b₂=I_{R n}−2I_{R n+50}

b₃=2Q_{R n}+Q_{R n+50} b₄=Q_{R n}−2Q_{R n+50} (6)

where I and Q can each have values between −3 and 3 depending on the magnitudes of the received Q and I components.

Multiplying the aforementioned minimum of the two CSIs with the soft bits (b1, b2, b3, b4) creates the ML soft bits. Specifically, as the CSI is a group of relative powers for the groups of frequencies, the powers associated with the n and n+50 frequencies are multiplied by the I and Q values. As a result, the group of 4 soft bits is created from:

b₁=(2I_{R n+}I_{R n+50})*min(CSIₙ,CSIₙ₊₅₀)

b₂=(I_{R n}−2I_{R n+50})*min(CSIₙ,CSIₙ₊₅₀)

b₃=(2Q_{R n+}Q_{R n+50})*min(CSIₙ,CSIₙ₊₅₀)

b₄=(Q_{R n}−2Q_{R n+50})*min(CSIₙ,CSIₙ₊₅₀) (7)

The soft bits from the DCM demapper are then inputted to the bit deinterleaver, the soft-bit Viterbi decoder and then descrambled to recover the PSDU.

### Simulations and Results

### Simulation Configuration

Two propagation models are presented here, an AWGN channel and Foerster's CM1 variant 1 [11]. Channel estimation using in CM1 is also specified in [11] for the channel environment. As in the MBOA tests [12], we adopted 500 packets with each packet of 1024 octets per PSDU in each simulation. We also maintain strict adherence to timing and use a hopping characteristic of TFC=1 and 100 channel realizations in multi-path environment. The Packet Error Rate (PER) performance is calculated using the mean for the best 90% channel realizations (top 90% ile [12]). Noise figure (NF)=6.6 dB is added in the receiver RF front end.

### Performance Gain

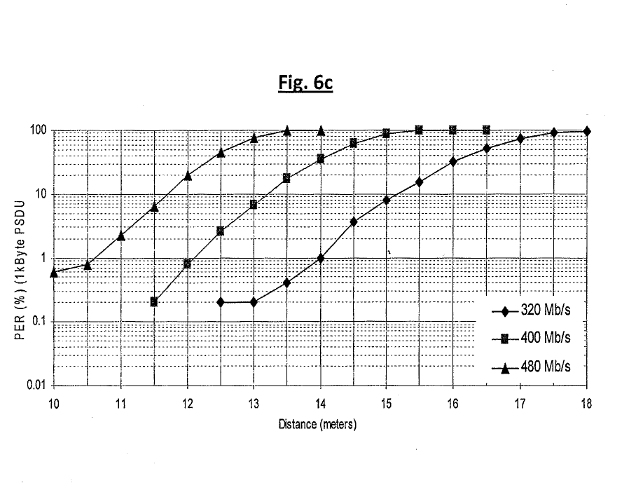

In multi-path environment the proposed DCM has gained improvement by exploiting CSI coupling with hopping information. FIG. 6a depicts particularly the performance difference between using CSI and no CSI in 480 Mbit/s mode and estimated data of 480 Mbit/s performance from Batra's result [7] in CM1. The proposed DCM increases the propagation distance for 480 Mbit/s mode to 4.3 m for reliable reception in CM1 (PER<8%), which is 13% improvement in comparison of Batra's result −3.8 m [7]. FIG. 6b depicts the performances for the proposed DCM exploiting a CSI aided scheme coupled with the band hopping information at the required high data rate transmission.

The performance in AWGN channel is also simulated, shown in FIG. 6c. Because CSI exits in multi-path environment only, the performance with CSI is as same as no CSI in AWGN channel.

It can therefore be seen that the DCM provides fast and reliable data modulation for mapping and demapping high data rate at 320 Mbit/s, 400 Mbit/s and 480 Mbit/s achieved by various levels of coding and diversity within the MB-OFDM system. The DCM demapper of some embodiments of this invention exploits a CSI aided scheme coupled with the band hopping information resulting in improved performance in high data rate transmission, particularly in the 480 Mbit/s mode, thereby increasing the propagation distance to be 4.3 m for reliable reception in CM1.

### REFERENCES

[1] Federal Communications Commission, “New Public Safety Applications And Broadband Internet Access Among Uses Envisiged by FCC Authorization of Ultra-Wideband Technology”, press release ]4 Feb. 2002, http://www.fcc.gov/Bureaus/Engineering_Technology/News_Releases/2002/nr et0203.html
[2] A. Batra, et al, “Multi-band OFDM physical layer proposal for IEEE 802.15 task group 3a,” IEEE standard proposal P802.15-03, March 2004, http://grouper.ieee.org/groups/802/15/pub/2003/Jul03/03268r3P802-15_TG3a-Multi-band-CFP-Document.doc
[3] R. Fisher, et al, “DS-UWB Physical Layer Submission to 802.15 Task Group 3a” IEEE standard proposal IEEE P802.15-04/0137r4, January 2005, http://grouper.ieee.org/groups/802/15/pub/2004/15-04-0137-04-003 a-merger2-proposal-ds-uwb-update.doc
[4] WiMedia Alliance http://www.wimedia.org/en/index.asp
[5] ECMA-368, “High Rate Ultra Wideband PHY and MAC Standard”, December 2005, http://www.ecma-international.org/publications/files/ECMA-ST/ECMA-368.pdf
[6] R. S. Sherratt, R. Yang, “A Dual QPSK Soft-demapper for Multiband OFDM exploiting Time-Domain Spreading and Guard Interval Diversity” IEEE Transactions on Consumer Electronics, vol. 53, no. 1, pp. 46-49, February 2007
[7] A. Batra, J. Balakrishnan “Improvements to the Multi-band OFDM Physical Layer”, Consumer Communications and Networking Conference, 2006. CCNC 2006. 2006 3rd IEEE, Vol 2, 8-10 January 2006 pp: 701-705
[8] M. R. G. Butler, S. Armour, P. N. Fletcher, A. R. Nix, and D. R. Bull, “Viterbi decoding strategies for 5 GHz wireless LAN systems,” in Proc. IEEE 54th Veh. Technol. Conf., VTC 2001 Fall, pp. 77 -81.
[9] W. Lee, H. Park, and Park J., “Viterbi decoding method using channel state information in COFDM system,” IEEE Transactions on Consumer Electronics, voL 45, no. 3, pp. 533-537, August 1999.
[10] W. Li, Z. Wang, Y. Yan, M. Tomisawa “An efficient low-cost LS equalization in COFDM based UWB systems by utilizing channel-state-information (CSI),” Vehicular Technology Conference, 2005. VTC-2005-Fall. 2005 IEEE 62nd, September 2005, Vol. 4, pp: 67-71
[11] J. Foerster, “Channel Modeling Sub-committee Report Final”, IEEE P802.15 Working Group for Wireless Personal Area Networks (WPANs), IEEE P802.15-02/490-SG3a. 7 Feb. 2003, http://grouper.ieee.org/groups/802/15/pub/2003/Mar03/02490r1P802-15_SG3a-Channel-Modeling-Subcommittee-Report-Final.zip
[12] MBOA standard “MultiBand OFDM Physical Layer Proposal for IEEE 802.15.3a”, September 2004, http://www.wimedia.org/imwp/idms/popups/pop_download.asp?ContentID=65 16

1. An OFDM communications system comprising a transmitter and a receiver, wherein the transmitter is arranged to:
define a plurality of band groups; transmit a plurality channel estimation sequences on each of the band groups, and transmit data on each of the band groups; and
the receiver is arranged to:
receive the channel estimation sequences;
for each band group to calculate channel state information from each of the channel estimation sequences transmitted on that band group and to form an average channel state information;
receive the transmitted data;
transform the received data into the frequency domain;
equalize the received data using the channel state information;
demap the equalized data to re-construct the received data as soft bits; and
modify the soft bits using the averaged channel state information.

2. A system according to claim 1 wherein each band comprises a plurality of sub-carrier frequencies and the channel state information comprises a set of relative powers for the respective sub-carrier frequencies, the soft bits have a magnitude associated with them, and the receiver is arranged to modify each soft bit by multiplying the magnitude of the soft bit by a relative power associated with one of the sub-carrier frequencies over which it was transmitted.

3. A system according to claim 2 wherein the transmitter is arranged to code the data so that one bit of data is transmitted over at least two of the sub-carrier frequencies.

4. A system according to claim 3 wherein the receiver is arranged to modify the soft bit by the lower of the relative powers associated with the at least two sub-carrier frequencies over which it was transmitted.

5. A receiver for an OFDM communications system, wherein the receiver is arranged to:
receive a plurality of channel estimation sequences each of which is received on one of a plurality of bands;
for each band group to calculate channel state information from each of the channel estimation sequences received on that band group and to form an average channel state information;
receive transmitted data;
transform the received data into the frequency domain;
equalize the received data using the channel state information;
demap the equalized data to re-construct the received data as soft bits; and
modify the soft bits using the averaged channel state information.

6. A receiver according to claim 5 wherein each band comprises a plurality of sub-carrier frequencies and the channel state information comprises a set of relative powers for the respective sub-carrier frequencies, the soft bits have a magnitude associated with them, and the receiver is arranged to modify each soft bit by multiplying the magnitude of the soft bit by a relative power of a sub-carrier frequency over which it was transmitted.

7. A receiver according to claim 6 wherein the transmitter is arranged to code the data so that one bit of data is transmitted over at least two sub-carrier frequencies.

8. A method of communicating over an OFDM communications system, the method comprising:
defining a plurality of band groups; transmitting a plurality of channel estimation sequences on each of the band groups, transmitting data on each of the band groups;
receiving the channel estimation sequences;
for each band group calculating channel state information from each of the channel estimation sequences transmitted on that band group and forming an average channel state information;
receiving the transmitted data;
transforming the received data into the frequency domain;
equalizing the received data using the channel state information;
demapping the equalized data to re-construct the received data as soft bits;
and modifying the soft bits using the averaged channel state information.
